(19) United States
(12) Patent Application Publication
(10) Pub. No.: US 2025/0329792 A1
(43) Pub. Date: Oct. 23, 2025

(54) CYLINDRICAL ELECTROCHEMICAL CELLS AND METHODS OF FORMING THE SAME

(71) Applicant: MEDTRONIC, INC., Minneapolis, MN (US)

(72) Inventor: Christian S. Nielsen, River Falls, WI (US)

(21) Appl. No.: 18/868,303

(22) PCT Filed: Apr. 24, 2023
(86) PCT No.: PCT/IB2023/054182

§ 371 Date: Nov. 22, 2024

Related U.S. Application Data
(60) Provisional application No. 63/347,188, filed on May 31, 2022.

(51) Int. Cl. H01M 10/0587; H01M 50/107; H01M 50/474; H01M 50/477

(52) U.S. Cl. CPC H01M 10/0587; H01M 50/107; H01M 50/474; H01M 50/477

(57) ABSTRACT

An electrochemical cells and methods of making the same are disclosed. An electrochemical cell may include a cell housing and a cell core. The cell housing may define a tubular cell body extending along a longitudinal axis from a distal end to a proximal end. The cell core may be disposed in the cell housing. The cell core may include a winding core extending along the longitudinal axis, a cathode, an anode, a plurality of inner windings, and a plurality of outer windings. The plurality of inner windings may be coiled around the winding core and define an inner diameter. The plurality of outer windings may be coiled around the plurality of inner windings and define an outer diameter.

### FIELD

The present disclosure relates to, among other things, cylindrical cell batteries or electrochemical cells.

### TECHNICAL BACKGROUND

Cylindrical cell batteries or electrochemical cells are generally easy to manufacture and provide robust mechanical stability. Such cylindrical cell batteries or electrochemical cells may include an anode, cathode, and a separator in the form of strips wound in a spiral or coil. While typical methods and processes for constructing cylindrical batteries or electrochemical cells are mature and low cost, such electrochemical cells and methods may result in lower energy densities than other cell types due to spaces or gaps formed during construction.

### BRIEF SUMMARY

As described herein, cylindrical batteries and electrochemical cells with increased energy density can be achieved using winding cores that form part of the electrochemical cell. The winding cores may be used to wind the cell cores when they are constructed. Such winding cores may allow a tighter winding of the cell core components when compared to traditional cylindrical batteries and electrochemical cells. Additionally, the winding cores may be used as an interconnect or current collector.

Described herein, among other things, is an electrochemical cell comprising a cell housing comprising a tubular cell body extending along a longitudinal axis from a distal end to a proximal end and a cell core disposed in the cell housing. The cell core may comprise a winding core extending along the longitudinal axis, a cathode electrode defining a plurality of cathode windings around the longitudinal axis, an anode electrode defining a plurality of anode windings around the longitudinal axis, a plurality of inner windings coiled around the winding core and defining an inner diameter, and a plurality of outer windings coiled around the plurality of inner windings and defining an outer diameter. Each of the plurality of inner windings may comprise one of the plurality of cathode windings or one of the plurality of anode windings. Each of the plurality of outer windings may comprise one of the plurality of cathode windings and one of the plurality of anode windings.

In general, in one aspect, the present disclosure describes a method for forming an electrochemical cell. The method may comprise providing a winding core extending along a longitudinal axis, coupling a first electrode to the winding core, and winding the first electrode around the winding core to form a partially wound cell core. The partially wound cell core may comprise a plurality of inner windings defining an inner diameter. The method may further include coupling a second electrode to the partially wound cell core; winding the first electrode and the second electrode around the partially wound battery core to form a cell core. The cell core may comprise the plurality of inner windings and a plurality of outer windings defining an outer diameter.

Advantages and additional features of the subject matter of the present disclosure will be set forth in the detailed description which follows, and in part will be readily apparent to those skilled in the art from that description or recognized by practicing the subject matter of the present disclosure as described herein, including the detailed description which follows, the claims, as well as the appended drawings.

It is to be understood that both the foregoing general description and the following detailed description present embodiments of the subject matter of the present disclosure, and are intended to provide an overview or framework for understanding the nature and character of the subject matter of the present disclosure as it is claimed. The accompanying drawings are included to provide a further understanding of the subject matter of the present disclosure and are incorporated into and constitute a part of this specification. The drawings illustrate various embodiments of the subject matter of the present disclosure and together with the description serve to explain the principles and operations of the subject matter of the present disclosure. Additionally, the drawings and descriptions are meant to be merely illustrative and are not intended to limit the scope of the claims in any manner.

### BRIEF DESCRIPTION OF THE DRAWINGS

The following detailed description of specific embodiments of the present disclosure can be best understood when read in conjunction with the following drawings, in which:

FIG. 1 is an isometric view of an embodiment of an electrochemical cell;

FIG. 2 is a cross-sectional view of the electrochemical cell of FIG. 1;

FIG. 3 is a cross-sectional view of a cell core of the electrochemical cell of FIGS. 1 and 2;

FIG. 4 is a perspective view of a winding core of the electrochemical cell of FIGS. 1 and 2.

FIG. 5 is a perspective view of another embodiment of an electrochemical cell;

FIG. 6 is a perspective view of a winding core of the electrochemical cell of FIG. 5; and

FIG. 7 is flow diagram of an embodiment of a process for determining a charging voltage of a battery.

FIG. 8 is a perspective view of a process for disposing insulators in the electrochemical cell of FIGS. 1 and 2 during formation of the electrochemical cell.

The schematic drawing is not necessarily to scale.

### DETAILED DESCRIPTION

Reference will now be made in greater detail to various embodiments of the subject matter of the present disclosure, some embodiments of which are illustrated in the accompanying drawings. Like numbers used in the figures refer to like components and steps. However, it will be understood that the use of a number to refer to a component in a given figure is not intended to limit the component in another figure labeled with the same number. In addition, the use of different numbers to refer to components in different figures is not intended to indicate that the different numbered components cannot be the same or similar to other numbered components.

Generally, in wound cylindrical batteries and electrochemical cells, a winding core is used to wind up the electrode pair making up the cathode and anode. In traditional cell designs, the winding core is temporary and removed after an electrode coil is formed. However, use of smaller cores as an interconnect or current collector in the finished electrochemical cell can allow the volume of the electrochemical cell to be used more efficiently. Additionally, such electrochemical cells may be wound tighter to reduce voids within the electrochemical cell and reduce lithium plating issues in wound lithium cells.

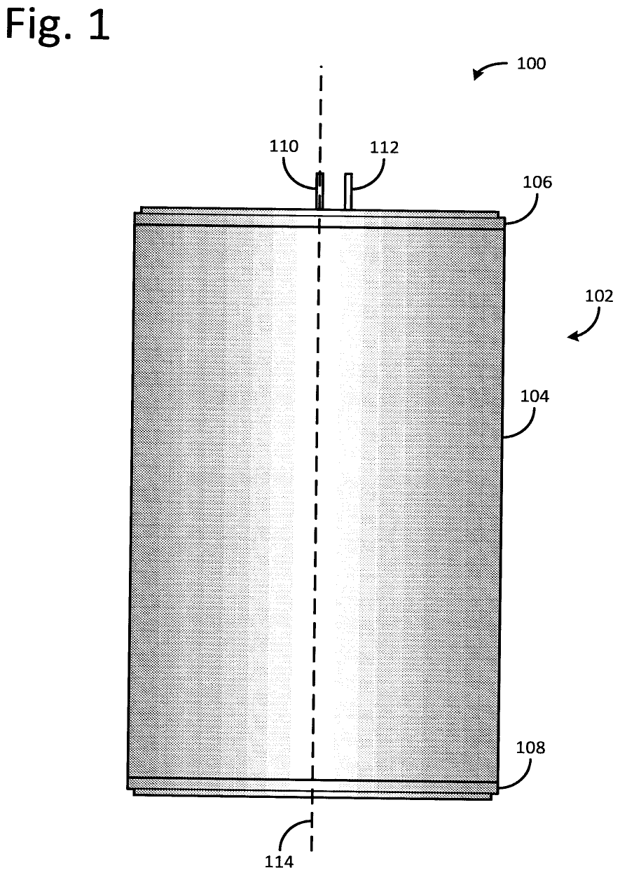

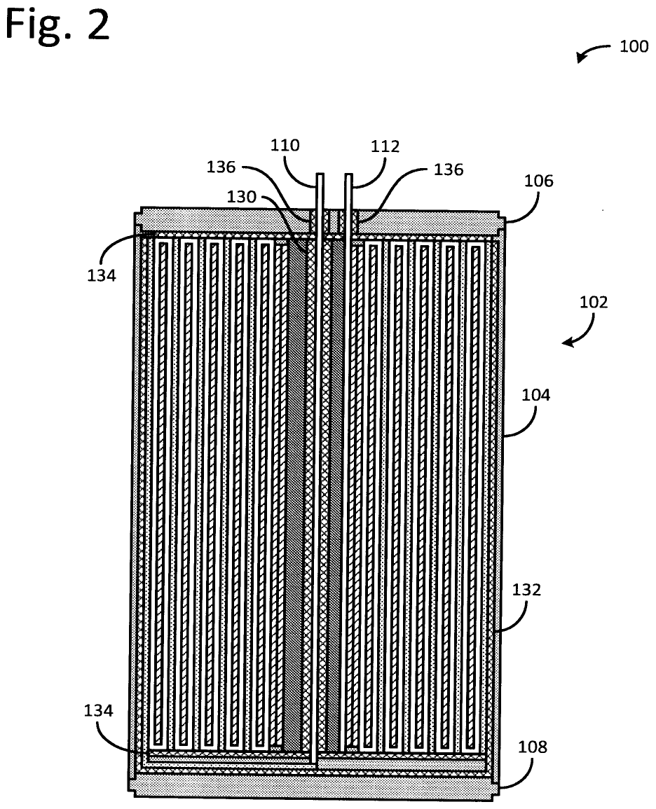

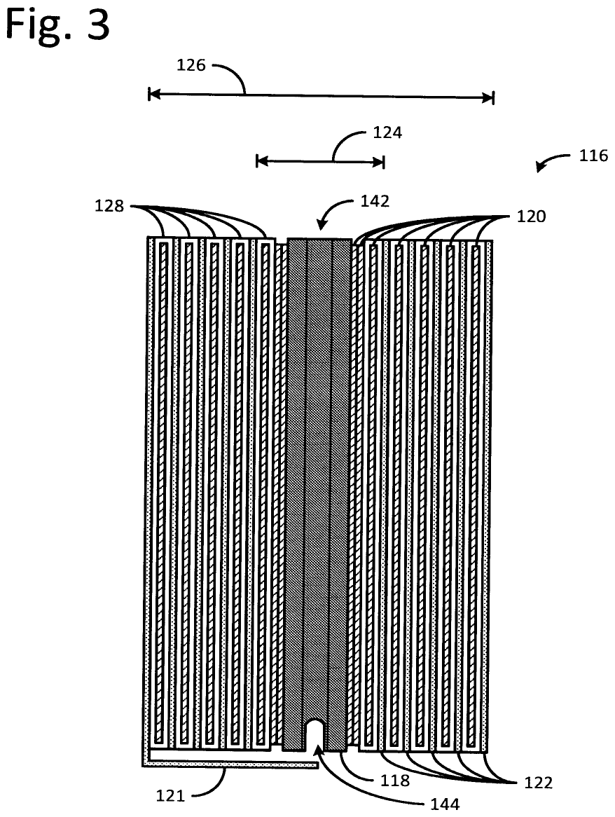

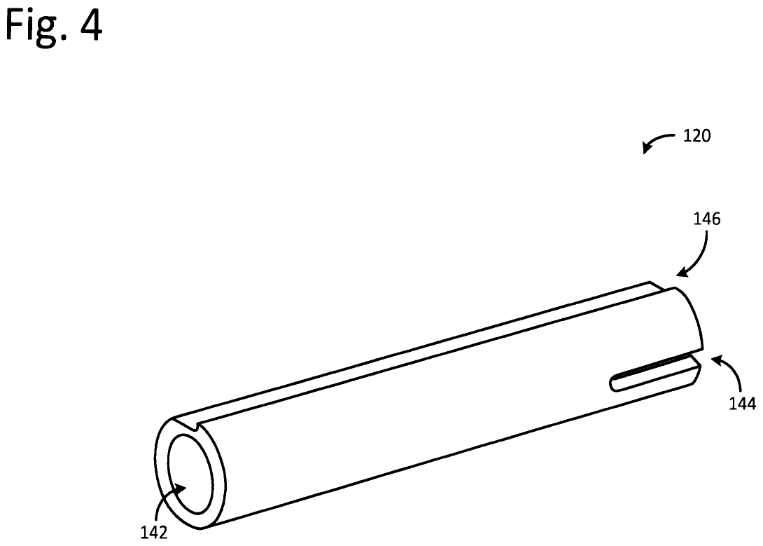

An electrochemical cell 100 that includes a winding core as described herein, is depicted in FIGS. 1 and 2. FIG. 1 shows a side view of an electrochemical cell 100. FIG. 2 shows a side cross-sectional view of the electrochemical cell 100. Additionally, FIG. 3 shows a side cross-sectional view of the cell core 116 of the electrochemical cell 100 and FIG. 4 shows an isometric view of the winding core 118 of the electrochemical cell 100. The electrochemical cell 100 may be any suitable electrochemical cell type such as, for example, lithium metal, lithium ferrophosphate, or lithium iron phosphate (LFP), lithium nickel manganese cobalt oxide (NMC), lithium nickel cobalt aluminum oxide (NCA), lithium titanate, etc.

The electrochemical cell 100 includes a cell housing 102 and a cell core 116. The cell housing 102 may include a cell body 104 extending along a longitudinal axis 114 from a distal end to a proximal end. As shown, the cell body 104 is a hollow cylinder. However, the cell body 104 may have any suitable outer shape when viewed from above along the longitudinal axis 114. For example, the outer shape of the cell body 104 may be polygonal, elliptical, or a combination of straight and curved edges. The cell body 104 may include one or more materials such as, for example, aluminum, titanium, stainless steel, nickel, nickel coated ferrous steels, or other suitable materials. In some embodiments, the cell body 104 may include a polymeric material.

The cell body 104 may also include a distal header 106 coupled to the distal end of the cell body 104 and a proximal header 108 coupled to the proximal end of the cell body 104. The distal header 106 and the proximal header 108 may be coupled to the cell body 104, for example, by an adhesive, a weld process, crimp closure, etc. The distal header 106 and the proximal header 108 may include one or more materials such as, for example, aluminum, stainless steel, nickel, nickel coated ferrous steels, or other suitable materials. In some embodiments, distal header 106 and the proximal header 108 may include a polymeric material.

The electrochemical cell may further include current collectors 110, 112. The current collectors 110, 112 may include one or more electrically conductive materials such as, for example, titanium, aluminum, copper, etc. The current collectors 110, 112 may each be electrically coupled to one of the electrodes of the electrochemical cell 100. In other words, the current collectors 110, 112 may include an anode current collector conductively coupled to the anode electrode 122 and a cathode current collector conductively coupled to the cathode electrode 120. Each of the current collectors 110, 112 may extend through the distal header 106. One or both of the current collectors 110, 112 may be electrically insulated from the distal header 106 and, by extension, the rest of the cell housing 102 including the cell body 104 and the proximal header 108. When both of the current collectors 110, 112 are electrically insulated from the cell housing 102, the electrochemical cell 100 may be considered “case neutral.” In other words, the cell housing 102 may float at the electrolyte potential of the electrochemical cell 100.

The cell core 116 may be disposed in the cell housing. The cell core 116 may include a winding core 118 extending along the longitudinal axis 114, a cathode electrode 120 defining a plurality of cathode windings around the longitudinal axis 114, and an anode electrode 122 defining a plurality of anode windings around the longitudinal axis 114. The cell core 116 may also include a plurality of inner windings coiled around the winding core 118 that define an inner diameter 124. As shown, the plurality of inner windings includes a plurality of the cathode windings. In some embodiments, the arrangement of the cathode electrode 120 and the anode electrode 122 may be swapped such that the plurality of inner windings includes a plurality of the anode windings. In other words, each of the plurality of inner windings may include one of the plurality of cathode windings or one of the plurality of anode windings. The plurality of inner windings may include either the cathode electrode 120 or the anode electrode 122 but not both. In other words, the plurality of inner windings does not include any of the plurality of cathode windings or does not include any of the plurality of anode windings. The cell core 116 may further include a plurality of outer windings coiled around the plurality of inner windings and defining an outer diameter 126. Each of the plurality of outer windings may include one of the plurality of cathode windings and one of the plurality of anode windings.

The winding core 118 may include a conductive tubular body that defines a lumen 142. The conductive tubular body of the winding core may extend parallel to the longitudinal axis 114. The current collector 110 may be arranged within the lumen 142 of the winding core 118 and may extend along or parallel to the longitudinal axis 114. An insulator 130 may be arranged between the winding core 118 and the current collector 110. The tubular body of the winding core 118 may define one or more notches 144 that extend parallel to the longitudinal axis 114 from an end of the tubular body towards the other end of the tubular body. The one or more notches 144 may be configured to mate with a winding tool. The one or more notches 144 may facilitate turning of the winding core 118 during a cell core winding process. The winding core 118 may further include a groove 146 in an outer surface of the tubular body. The groove 146 may extend parallel to the longitudinal axis 114 along at least a portion of the tubular body. The groove 146 may be shaped to receive the current collector 110.

The cathode electrode 120 may include a strip of conductive material wound about the winding core 118. The cathode electrode 120 may include any one or more materials such as, for example, lithium-metal oxides (e.g., LiCoO2, LiMn2O4, Li(NixMnyCoz)O2, etc.), vanadium oxides, olivines (e.g., LiFePO4), rechargeable lithium oxides, etc. As shown, the cathode electrode 120 is electrically and mechanically coupled to the winding core 118. Additionally, the cathode electrode 120 is electrically and mechanically coupled to the current collector 112. Alternatively, arrangement of the cathode electrode 120 and the anode electrode may be switched such that the cathode electrode 120 is electrically and mechanically coupled to the current collector 110 while being electrically insulated from the winding core 118 and the current collector 112. The cathode may be electrically and mechanically coupled to the current collector 110 via an electrode tab. The electrode tab may be integrally formed with the cathode electrode 120 or coupled to the cathode electrode 120. The cathode electrode 120 may be electrically and mechanically coupled to any of the winding core 118, the current collector 110, the current collector 112, or an electrode tab by, for example, a weld line, a conductive adhesive, solder, etc.

The anode electrode 122 may include a strip of conductive material wound about the winding core 118. The anode electrode 122 may include any one or more materials such as, for example, lithium, graphite, lithium-alloying materials, intermetallic materials (e.g., alloys), silicon, copper, etc. In some embodiments, the anode electrode 122 may include a copper foil. The copper foil may include a of metallic lithium. As shown, the anode electrode 122 is mechanically and electrically coupled to the current collector 110 via an electrode tab 121. The electrode tab 121 may be integrally formed with the anode electrode 122 or coupled to the anode electrode 122. Alternatively, the arrangement of the cathode electrode 120 and the anode electrode may be switched such that the anode electrode is mechanically and electrically coupled to the winding core 118 and the current collector 112 while being insulated from the current collector 110. The anode electrode may be electrically and mechanically coupled to any of the winding core 118, the current collector 110, the current collector 112, or an electrode tab by, for example, a weld line, a conductive adhesive, solder, etc.

The cell core 116 may further include a separator 128 arranged between the cathode electrode 120 and the anode electrode 122. The separator 128 may define a plurality of separator windings around the longitudinal axis 114. In some embodiments, the separator 128 may include a tube that surrounds or “wraps” a portion of one of the cathode electrode 120 or the anode electrode 122. In some embodiments, the separator 128 may include two or more strips disposed on both sides of the cathode electrode 120 or the anode electrode 122. Each of the plurality of outer windings may include the separator 128 disposed between the cathode electrode 120 and the anode electrode 122. The separator 128 may formed of electrically insulative material or materials. The separator 128 may include one or more materials such as, for example, Polytetrafluoroethylene (PTFE), cellophane, nylon, polyolefin, etc. Additionally, the separator may be porous to allow ion transfer between the cathode electrode 120 and the anode electrode 122 via an electrolyte.

The electrochemical cell 100 may further include an electrolyte disposed in the cell housing 102. Although not explicitly labeled in the FIG. 2, the electrolyte may generally fill at least a portion of any spaces inside the cell housing 102 not filled by the other components of the electrochemical cell 100. The electrolyte may facilitate ion transfer between the cathode electrode 120 and the anode electrode 122. The electrolyte may have an electrical potential. When the current collectors 110, 112 are electrically isolated from the cell housing 102, the cell housing 102 may float at the electrical potential of the electrolyte. The electrolyte may be one or more of, for example, a liquid, a gel, a paste, etc. The material composition of the electrolyte may depend on a cell type of the electrochemical cell 100. The electrolyte may include, for example, lithium salt, sulfuric acid, fluorinated sulfone, or other suitable electrolyte.

The electrochemical cell 100 may also include various insulators to insulate the conductive components (e.g., the cell housing 102; the current collectors 110, 112; the cathode electrode 120, the anode electrode 122, etc.) from one another. An insulator 130 may be arranged between the winding core 118 and the current collector 110. In some embodiments, the insulator 130 may be a core extruded microtube. The insulator 130 may include one or more insulative materials such as, for example, Polytetrafluoroethylene (PTFE), Polysulfone, etc.

Additionally, the electrochemical cell 100 may include an insulator cup 132 disposed between the plurality of outer windings and the cell housing 102. In some embodiments, the insulator cup 132 may include a heat shrinkable material to conform to the shape of the cell core 116. The insulator cup 132 may include, for example, Polytetrafluoroethylene (PTFE), Polysulfone, etc. The insulator cup 132 may be open at one end.

The electrochemical cell 100 may also include coaxial insulators 134. The coaxial insulators 134 may provide an insulative barrier between the edges of the plurality of windings and conductive components such as one of the headers 106, 108 or an interconnect such as electrode tab 121. The coaxial insulators 134 may include, for example, Polytetrafluoroethylene (PTFE), Polysulfone, etc.

The electrochemical cell 100 may also include feedthrough insulators 136. The feedthrough insulators 136 may be disposed in one of the headers 106, 108 to electrically insulate the headers 106, 108 from electrical interconnects such as the current collectors 110, 112. The feedthrough insulators 136 may include, for example, glass, ceramic materials (e.g., alumina), or other suitable insulative materials.

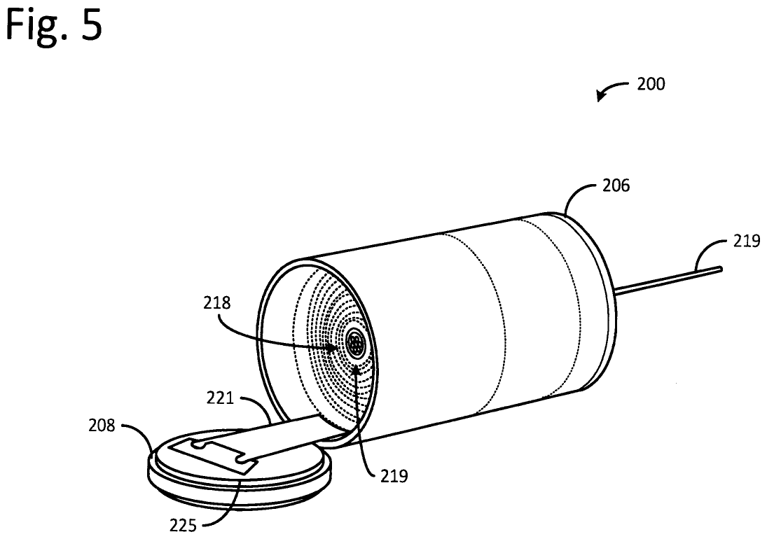

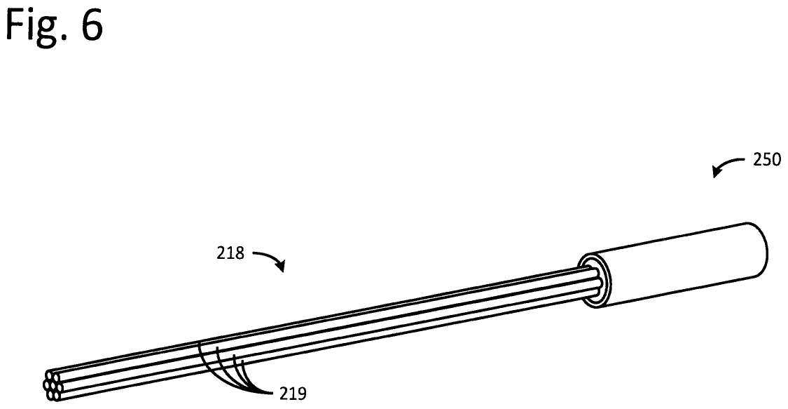

Another embodiment of an electrochemical cell 200 is depicted in FIG. 5. The electrochemical cell 200 may include the components and features of the electrochemical cell 100 of FIGS. 1 and 2 with some differences and variations as described below. For example, the electrochemical cell 200 includes a winding core 218 that includes a plurality of pins 219 as shown in FIGS. 5 and 6. The winding core 218 is depicted attached to a winding tool 250 prior to formation of a cell core of the electrochemical cell 200 in FIG. 6.

Each of the plurality of pins 219 may extend along or parallel to a longitudinal axis of the electrochemical cell 200. Each pin of the plurality of pins 219 may take on any suitable elongated shape such as, for example, an elongated cylinder, an elongated polyhedron, etc. Each of the plurality of pins 219 may include, for example, titanium, titanium, vanadium, niobium etc. One or more of the plurality of pins 219 may be electrically and mechanically coupled to one of the electrodes (e.g., the cathode electrode or the anode electrode) of the electrochemical cell. At least one of the plurality of pins 219 may extend through a header of the electrochemical cell to provide an interconnect and act as a current collector for one of the electrodes of the electrochemical cell 200. Prior to formation of the cell core of the electrochemical cell 200, the plurality of pins 219 may be held together by the winding tool 250. The winding tool 250 may hold the plurality of pins 219 with, for example, an epoxy, a glass, a clamp, etc.

Another difference between the electrochemical cell 200 and the electrochemical cell 100 is that the electrochemical cell 200 has a “case negative” design. As shown, the anode electrode is electrically and mechanically coupled to a proximal header 208 of the electrochemical cell via an electrode tab 221. Accordingly, the proximal header 208 may be at or near the electric potential of the anode electrode of the electrochemical cell. The electrode tab 221 may be coupled to the proximal header 208 by a coupling element 225. The coupling element 225 may include, for example, a clip, a weld, a conductive adhesive, solder, etc.

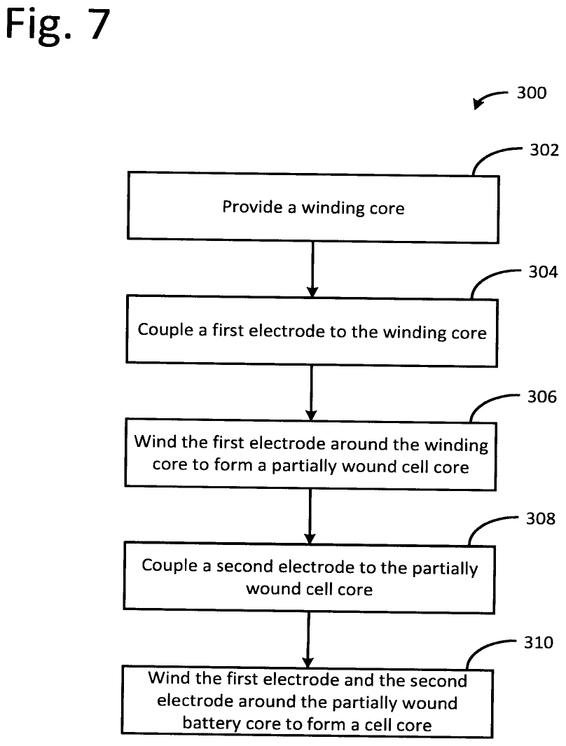

A method or process 300 for forming an electrochemical cell (e.g., electrochemical cell 100 of FIGS. 1 and 2 or electrochemical cell 200 of FIG. 5) is depicted in FIG. 7. The method 300 may include providing a winding core extending along a longitudinal axis 302. The winding core may include the winding core 118 of FIGS. 1-4 or the winding core 218 of FIGS. 5 and 6.

The method 300 may include coupling a first electrode to the winding core 304. The first electrode may be a cathode electrode (e.g., cathode electrode 120 of FIGS. 1-3) or an anode electrode (e.g., anode electrode 122 of FIGS. 1-3). Coupling the first electrode to the winding core may include conductively and mechanically coupling the first electrode to the winding core. The first electrode may be coupled to the winding core using any suitable technique or techniques. For example, coupling the first electrode to the winding core may include one or more of, for example, welding the first electrode to the winding core, adhering the first electrode to the winding core, soldering the first electrode to the winding core, fixing an edge of the first electrode between two or more pins (e.g., the plurality of pins 219 of FIGS. 5 and 6) of the winding core, disposing a portion of the first electrode in a groove of the winding core (e.g., the groove 146 of FIG. 4), etc. In some embodiments, coupling the first electrode to the winding core includes welding the first electrode to the winding core. In some embodiments, coupling the first electrode to the winding core comprises laser welding the first electrode and a current conductor to the winding core.

The method 300 may include winding the first electrode around the winding core to form a partially wound cell core comprising a plurality of inner windings defining an inner diameter 306. To wind the core to form a partially wound cell core, the method 300 may include engaging one or more notches (e.g., the one or more notches 144 of FIGS. 3 and 4) of the winding core with a winding tool. Winding the core may include rotating the winding core around the longitudinal axis using the winding tool. The winding tool may include, for example, a chuck, a spindle, a motor, or any other device or apparatus to hold and rotate the winding core.

The method 300 may also include disposing a separator (e.g., separator 128 of FIGS. 1-3) on a portion of the first electrode prior to winding the first electrode around the winding core to form the partially wound cell core. Disposing the separator on the portion of the first electrode may include inserting the portion of the first electrode into a separator tube. In some embodiments, a first separator strip is disposed on a first side of the first electrode and a second separator strip is disposed on a second side of the first electrode prior to winding the first electrode around the winding core to form the partially wound cell core.

The method 300 may include coupling a second electrode to the partially wound cell core 308. The second electrode may be a cathode electrode (e.g., cathode electrode 120 of FIGS. 1-3) or an anode electrode (e.g., anode electrode 122 of FIGS. 1-3). In general, the second electrode may be an anode electrode when the first electrode is a cathode electrode and the second electrode may be a cathode electrode when the first electrode is an anode electrode. Coupling the second electrode to the partially wound cell core may include inserting an end of the second electrode in between two windings of the partially wound cell core.

The method 300 may include winding the first electrode and the second electrode around the partially wound battery core to form a cell core 310. The cell core (e.g., cell core 116 of FIGS. 1-3) may include the plurality of inner windings and a plurality of outer windings defining an outer diameter.

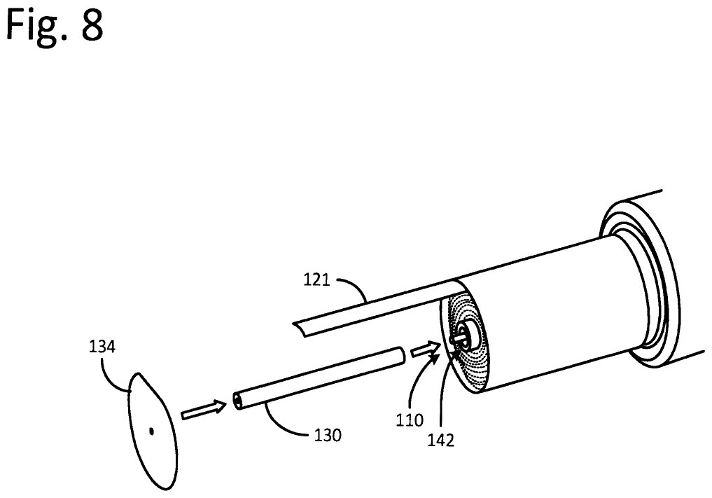

The method 300 may further include disposing a current collector (e.g., the current collector 110 of FIGS. 1 and 2) into a lumen of the winding core. Additionally, an insulator (e.g., the insulator 130 of FIG. 2) may be disposed between the current collector and the winding core. The insulator may fill the space between the current collector and the winding core. For example, as depicted in FIG. 8, the insulator 130 may be inserted into the lumen 142 such that the insulator 130 surrounds the current collector 110 and electrically insulates the current collector 110 from the winding core 118.

The method 300 may further include coupling the second electrode to the current collector. The second electrode may be coupled to the current collector using any suitable technique or techniques such as, for example, welding, or any other technique for electrically coupling two electrically conductive elements. The second electrode may be coupled to the current collector after a coaxial insulator (e.g., the coaxial insulator 134 of FIG. 2) is disposed between the plurality of windings and an electrode tab. For example, as depicted in FIG. 8, the coaxial insulator 134 may be disposed over the plurality of windings and the winding core 118 while allowing the current collector 110 to pass through an opening in the coaxial insulator 134. After the coaxial insulator 134 has been disposed over the plurality of windings and the winding core 118, the electrode tab 121 may be brought into contact with the current collector 110 and electrically coupled to the current collector 110 without being electrically coupled to the other electrode.

The method 300 may further include disposing the cell core in an insulator cup (e.g., insulator cup 132 of FIG. 2). Disposing the cell core in the insulator cup may include inserting the cell core in the insulator cup. Disposing the cell core in the insulator cup may further include applying heat to the insulator cup after the cell core is received in the insulator cup to cause the insulator cup to shrink fit to the cell core.

The method 300 may further include disposing one or more coaxial insulators (e.g., coaxial insulators 134 of FIG. 2) ends of the cell core such that the one or more coaxial insulators insulate edges of the plurality of windings. At least one coaxial insulator may be disposed prior to disposing the cell core in an insulator cup.

The method 300 may further include disposing the cell core into a cell body (e.g., cell body 104 of FIGS. 1 and 2) defining a tubular cell body extending along the longitudinal axis from a distal end to a proximal end. The method 300 may further include coupling a distal header (e.g., distal header 106 of FIGS. 1 and 2 or distal header 206 of FIG. 5) to the distal end of the cell body. Coupling the distal header to the cell body may include welding the distal header to the cell body. The method 300 may further include coupling a proximal header (e.g., proximal header 108 of FIGS. 1 and 2 or proximal header 208 of FIG. 5) to the proximal end of the cell body. Coupling the proximal header to the cell body may include welding the distal header to the cell body. The cell body, distal header, and proximal header may form a cell housing (e.g., cell housing 102 of FIGS. 1 and 2). The method 300 may further include disposing an electrolyte into the cell housing.

The invention is defined in the claims. However, below there is provided a non-exhaustive list of non-limiting examples. Any one or more of the features of these examples may be combined with any one or more features of another example, embodiment, or aspect described herein.

Example Ex1: An electrochemical cell comprising: a cell housing comprising a cell body extending along a longitudinal axis from a distal end to a proximal end; and a cell core disposed in the cell housing, the cell core comprising: a winding core extending along the longitudinal axis; a cathode electrode defining a plurality of cathode windings around the longitudinal axis; an anode electrode defining a plurality of anode windings around the longitudinal axis; a plurality of inner windings coiled around the winding core and defining an inner diameter, each of the plurality of inner windings comprising one of the plurality of cathode windings or one of the plurality of anode windings; and a plurality of outer windings coiled around the plurality of inner windings and defining an outer diameter, each of the plurality of outer windings comprising: one of the plurality of cathode windings; and one of the plurality of anode windings.

Example Ex2: The electrochemical cell of example Ex1, wherein the winding core comprises a conductive tubular body defining a lumen, the conductive tubular body extending parallel to the longitudinal axis and wherein the electrochemical cell comprises: a current collector arranged within the lumen of the winding core and extending along or parallel to the longitudinal axis; and an insulator arranged between the winding core and the current collector.

Example Ex3: The electrochemical cell as in example Ex2, wherein the tubular body of the winding core defines one or more notches extending parallel to the longitudinal axis and configured to mate with a winding tool.

Example Ex4: The electrochemical cell as in example Ex2, wherein the current collector is conductively coupled to one of the cathode electrode or the anode electrode.

Example Ex5: The electrochemical cell as in example Ex1, wherein each of the plurality of outer windings further comprises a separator disposed between the one of the plurality of cathode windings and the one of the plurality of anode windings.

Example Ex6: The electrochemical cell as in example Ex1, wherein the plurality of outer windings further comprises a separator surrounding each cathode winding of the plurality of outer windings or each anode winding of the plurality of outer windings.

Example Ex7: The electrochemical cell as in example Ex1, wherein the cell housing further comprises: a distal header coupled to the distal end of the cell housing; and a proximal header coupled to the proximal end of the cell housing.

Example Ex8: The electrochemical cell as in example Ex7, further comprising: an anode current collector conductively coupled to the anode electrode and extending through the distal header; and a cathode current collector conductively coupled to the cathode electrode and extending through the distal header.

Example Ex9: The electrochemical cell as in example Ex1, wherein electrochemical cell further comprises an electrolyte disposed in the cell housing, and wherein the cell housing floats at an electrical potential of the electrolyte.

Example Ex10: The electrochemical cell as in example Ex1, wherein the plurality of inner windings does not include any of the plurality of cathode windings or does not include any of the plurality of anode windings.

Example Ex11: The electrochemical cell as in example Ex1, further comprising an insulator cup disposed between the plurality of outer windings and the cell housing.

Example Ex12: The electrochemical cell as in example Ex1, wherein the winding core comprises a plurality of pins extending along or parallel to the longitudinal axis.

Example Ex13: A method for forming an electrochemical cell comprising: providing a winding core extending along a longitudinal axis; coupling a first electrode to the winding core; winding the first electrode around the winding core to form a partially wound cell core comprising a plurality of inner windings defining an inner diameter; coupling a second electrode to the partially wound cell core; and winding the first electrode and the second electrode around the partially wound cell core to form a cell core comprising: the plurality of inner windings; and a plurality of outer windings defining an outer diameter.

Example Ex14: The method as in example Ex13, further comprising disposing a separator on a portion of the first electrode prior to winding the first electrode around the winding core to form the partially wound cell core.

Example Ex15: The method as in example Ex13, further comprising disposing a first separator strip on a first side of the first electrode and disposing a second separator strip on a second side of the first electrode prior to winding the first electrode around the winding core to form the partially wound cell core.

Example Ex16: The method as in example Ex13, further comprising: disposing a current collector into a lumen of the winding core; and disposing an insulator between the current collector and the winding core.

Example Ex17: The method as in example Ex16, further comprising coupling the second electrode to the current collector.

Example Ex18: The method as in example Ex13, wherein coupling the first electrode to the winding core comprises conductively and mechanically coupling the first electrode to the winding core.

Example Ex19: The method as in example Ex13, wherein coupling the first electrode to the winding core comprises welding the first electrode to the winding core.

Example Ex20: The method as in example Ex13, wherein coupling the first electrode to the winding core comprises laser welding the first electrode and a current conductor to the winding core.

Example Ex21: The method as in example Ex13, further comprising engaging one or more notches of the winding core with a winding tool, the one or more notches extending parallel to the longitudinal axis and wherein winding the first electrode around the winding core comprises rotating the winding core about the longitudinal axis using the winding tool.

Example Ex22: The method as in example Ex13, further comprising disposing the cell core into an insulator cup.

Example Ex23: The method as in example Ex13, further comprising disposing the cell core into a cell body extending along the longitudinal axis from a distal end to a proximal end.

Example Ex24: The method as in example Ex23, further comprising: coupling a distal header to the distal end of the cell body; and coupling a proximal header to the proximal end of the cell body.

All scientific and technical terms used herein have meanings commonly used in the art unless otherwise specified. The definitions provided herein are to facilitate understanding of certain terms used frequently herein and are not meant to limit the scope of the present disclosure.

As used herein, singular forms “a,” “an” and “the” include plural referents unless the context clearly dictates otherwise. As used in this specification and the appended claims, the term “or” is generally employed in its sense including “and/or” unless the content clearly dictates otherwise. The term “and/or” means one or all of the listed elements or a combination of any two or more of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the inventive technology.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred. Any recited single or multiple feature or aspect in any one claim can be combined or permuted with any other recited feature or aspect in any other claim or claims.

It will be apparent to those skilled in the art that various modifications and variations can be made to the present inventive technology without departing from the spirit and scope of the disclosure. Since modifications, combinations, sub-combinations and variations of the disclosed embodiments incorporating the spirit and substance of the inventive technology may occur to persons skilled in the art, the inventive technology should be construed to include everything within the scope of the appended claims and their equivalents.

1. An electrochemical cell comprising:
a cell housing comprising a cell body extending along a longitudinal axis from a distal end to a proximal end; and
a cell core disposed in the cell housing, the cell core comprising:
a winding core extending along the longitudinal axis;
a cathode electrode defining a plurality of cathode windings around the longitudinal axis;
an anode electrode defining a plurality of anode windings around the longitudinal axis;
a plurality of inner windings coiled around the winding core and defining an inner diameter, each of the plurality of inner windings comprising one of the plurality of cathode windings or one of the plurality of anode windings; and
a plurality of outer windings coiled around the plurality of inner windings and defining an outer diameter, each of the plurality of outer windings comprising:
one of the plurality of cathode windings; and
one of the plurality of anode windings.

2. The electrochemical cell of claim 1, wherein the winding core comprises a conductive tubular body defining a lumen, the conductive tubular body extending parallel to the longitudinal axis and wherein the electrochemical cell comprises:
a current collector arranged within the lumen of the winding core and extending along or parallel to the longitudinal axis; and
an insulator arranged between the winding core and the current collector.

3. The electrochemical cell as in claim 2, wherein the tubular body of the winding core defines one or more notches extending parallel to the longitudinal axis and configured to mate with a winding tool.

4. The electrochemical cell as in claim 2, wherein the current collector is conductively coupled to one of the cathode electrode or the anode electrode.

5. The electrochemical cell as in claim 1, wherein each of the plurality of outer windings further comprises a separator disposed between the one of the plurality of cathode windings and the one of the plurality of anode windings.

6. The electrochemical cell as in claim 1, wherein the plurality of outer windings further comprises a separator surrounding each cathode winding of the plurality of outer windings or each anode winding of the plurality of outer windings.

7. The electrochemical cell as in claim 1, wherein the cell housing further comprises:
a distal header coupled to the distal end of the cell housing; and
a proximal header coupled to the proximal end of the cell housing.

8. The electrochemical cell as in claim 7, further comprising:
an anode current collector conductively coupled to the anode electrode and extending through the distal header; and
a cathode current collector conductively coupled to the cathode electrode and extending through the distal header.

9. The electrochemical cell as in claim 1, wherein electrochemical cell further comprises an electrolyte disposed in the cell housing, and wherein the cell housing floats at an electrical potential of the electrolyte.

10. The electrochemical cell as in claim 1, wherein the plurality of inner windings does not include any of the plurality of cathode windings or does not include any of the plurality of anode windings.

11. The electrochemical cell as in claim 1, further comprising an insulator cup disposed between the plurality of outer windings and the cell housing.

12. The electrochemical cell as in claim 1, wherein the winding core comprises a plurality of pins extending along or parallel to the longitudinal axis.

13. A method for forming an electrochemical cell according to any comprising:
providing a winding core extending along a longitudinal axis;
coupling a first electrode to the winding core;
winding the first electrode around the winding core to form a partially wound cell core comprising a plurality of inner windings defining an inner diameter;
coupling a second electrode to the partially wound cell core; and
winding the first electrode and the second electrode around the partially wound cell core to form a cell core comprising:
the plurality of inner windings; and
a plurality of outer windings defining an outer diameter.

14. The method as in claim 13, further comprising:
disposing a current collector into a lumen of the winding core; and
disposing an insulator between the current collector and the winding core.

15. The method as in claim 13, further comprising disposing a separator on a portion of the first electrode prior to winding the first electrode around the winding core to form the partially wound cell core.

16. The method as in claim 13, further comprising disposing a first separator strip on a first side of the first electrode and disposing a second separator strip on a second side of the first electrode prior to winding the first electrode around the winding core to form the partially wound cell core.

17. The method as in claim 13, wherein coupling the first electrode to the winding core comprises conductively and mechanically coupling the first electrode to the winding core.

18. The method as in claim 13, wherein coupling the first electrode to the winding core comprises welding the first electrode to the winding core.

19. The method as in claim 13, wherein coupling the first electrode to the winding core comprises laser welding the first electrode and a current conductor to the winding core.

20. The method as in claim 13, further comprising engaging one or more notches of the winding core with a winding tool, the one or more notches extending parallel to the longitudinal axis and wherein winding the first electrode around the winding core comprises rotating the winding core about the longitudinal axis using the winding tool.
